(19) United States
(12) Patent Application Publication
(10) Pub. No.: US 2026/0266256 A1
(43) Pub. Date: Sep. 10, 2026

(54) A PITCH CONTROLLED WIND TURBINE

(71) Applicant: Vestas Wind Systems A/S, Aarhus N. (DK)

(72) Inventors: Mikkel Kiilerich Østerlund, Brabrand (DK); Efstratios Saliveros, Bristol (GB); Robert Thomas Rudolf, Aarhus C (DK)

(73) Assignee: Vestas Wind Systems A/S, Aarhus N. (DK)

(21) Appl. No.: 19/165,280

(22) PCT Filed: Mar. 14, 2024
(86) PCT No.: PCT/DK2024/050047

§ 371 Date: Sep. 15, 2025

(30) Foreign Application Priority Data
Mar. 17, 2023 (DK) PA202370135

(51) Int. Cl. F03D 1/06

(52) U.S. Cl. CPC F03D 1/0664; F03D 1/0681; F05B 2260/70

(57) ABSTRACT

A pitch controlled wind turbine has a tower, a nacelle mounted on the tower, a hub mounted rotatably on the nacelle, and at least three wind turbine blades. Each wind turbine blade extends between a root end connected to the hub via a pitch mechanism, and a tip end. The wind turbine has at least three blade connecting members, each blade connecting member extending from a connection point on one wind turbine blade towards a connection point on a neighbouring wind turbine blade. The connection point on a given wind turbine blade is arranged at a distance from the root end and at a distance from the tip end of the wind turbine blade. Each wind turbine blade has a leading edge, a leading edge extension, and a blade shell defining a suction side and a pressure side around the blade. The leading edge extension extends forward of the leading edge, and the connection point of the respective wind turbine blade is located forward of the leading edge and adjacent the pressure side on the leading edge extension. Each wind turbine blade has a

### FIELD OF THE INVENTION

The present invention relates to a pitch controlled wind turbine.

### BACKGROUND OF THE INVENTION

Wind turbine blades are subject to various loads. The loads typically include aerodynamic forces generated by the wind, including air pressure on the blades, changing wind speed and direction, as well as loads originating from the dead weight of the blade itself.

There is a continued drive to produce larger wind turbine blades, due to the increased energy production that is produced. Yet, as the size of wind turbine blades continues to increase, the loads on the wind turbine blades also continue to increase. The increased loads often require further reinforcement of the blades; however, this reinforcement further increases the weight of the blades, with a subsequent further increase in the loads acting on the blades.

### SUMMARY OF THE INVENTION

A first aspect of the invention provides a pitch controlled wind turbine comprising a tower, a nacelle mounted on the tower, a hub mounted rotatably on the nacelle, and at least three wind turbine blades, wherein each wind turbine blade extends between a root end connected to the hub via a pitch mechanism, and a tip end; the wind turbine further comprising at least three blade connecting members, each blade connecting member extending from a connection point on one wind turbine blade towards a connection point on a neighbouring wind turbine blade, where the connection point on a given wind turbine blade is arranged at a distance from the root end and at a distance from the tip end of the wind turbine blade; wherein each wind turbine blade comprises a leading edge, a leading edge extension, and a blade shell defining a suction side and a pressure side around the blade, wherein the leading edge extension extends forward of the leading edge, and the connection point of the respective wind turbine blade is located forward of the leading edge and adjacent the pressure side on the leading edge extension, and each wind turbine blade further comprises a respective fairing extending over at least the leading edge extension, wherein the fairing has a profile which is twisted nose down with respect to a profile of the blade shell adjacent the fairing.

The blade connecting members may cause the wind turbine blades to mutually support each other, in the sense that loads on the wind turbine blades, in particular edgewise loads and flatwise loads, are ‘shared’ among the wind turbine blades.

Providing a fairing extending over at least the leading edge extension may improve aerodynamic performance of the wind turbine blade compared to a wind turbine blade having a leading edge extension coupled to the blade connecting member but with no fairing extending over the leading edge extension.

Each wind turbine blade may have a trailing edge. The respective fairing may extend at least up to the trailing edge of the wind turbine blade.

The fairing may extend beyond the trailing edge of the wind turbine blade. The fairing may have a width measured in the spanwise direction of the wind turbine blade. A portion of the fairing extending beyond the trailing edge may have a width-wise taper, e.g. a taper of reducing width in the downstream chordwise direction. Arranging the fairing with a width-wise taper extending beyond the trailing edge of the turbine blade may improve aerodynamic performance.

The fairing profile may be an aerofoil profile. The fairing aerofoil profile may have a different shape than an aerofoil profile of the blade shell adjacent the fairing. This different shape may allow the fairing profile to extend over the leading edge extension extending forward of the leading edge of the blade but without having the same scalable shape (i.e. invariant of chord length) as the aerofoil profile of the blade shell adjacent the fairing.

The fairing profile may have a camber distribution. The camber distribution of the fairing may be different than a camber distribution of the profile of the blade shell adjacent the fairing.

The fairing profile may have a thickness distribution. The thickness distribution of the fairing may be different than a thickness distribution of the profile of the blade shell adjacent the fairing.

Each wind turbine blade may be coupled to two of the blade connecting members. Each of the two blade connecting members may extend from respective connection points of one of the blades. The connection points of the one of the wind turbine blades may be adjacent each other on the same leading edge extension. Providing connection points adjacent each other on the same leading edge extension may allow a compact leading edge extension to be provided, which may reduce the size of fairing required to extend over the leading edge extension. Each blade connecting member may be independently moveable at the respective first and second connection points to which it attaches. The connection point(s) may comprise a bearing structure.

The connection points on the wind turbine blades may be arranged at a distance from the root end which is between 10% and 60% of the length of the wind turbine blades from the root end to the tip end, preferably radially inboard of 50% of the length of the respective wind turbine blade from the root end, and more preferably radially inboard of 45% of the length of the respective wind turbine blade from the root end.

The connection points on the wind turbine blades may be arranged at a position where a thickness-to-chord ratio of the wind turbine blade is between 20% and 50%.

The respective fairing may have at least one aperture. At least one of the blade connecting members may extend from the connection point on the leading edge extension covered by the fairing and through the aperture towards the connection point on the neighbouring wind turbine blade.

Each aperture may be substantially ovoid and/or elongate and/or kidney-shaped. Each aperture may be shaped according to the direction in which the blade connecting member extends from the leading edge extension. For example, the blade connecting member makes a range of angles with the leading edge extension throughout the pitch range of motion of the wind turbine blade (e.g. −5 degrees to +95 degrees), and throughout this range of angles the aperture should accommodate the blade connecting member without impingement, yet it is desirable that the aperture be as small as possible.

The respective fairing may have two apertures. A respective one of the two blade connecting members may extend through a respective one of the two apertures. Arranging the blade connecting members as such may allow the size of the apertures to be minimised, which may help prevent ingress of water into the fairing and may improve strength of the fairing.

The one or more apertures may be covered or sealed around the one or more blade connecting members. Providing the apertures as such may prevent ingress of water into the fairing.

The respective fairing may have an inboard side facing towards the root end of the wind turbine blade. The respective fairing may have an outboard side facing towards the tip end of the wind turbine blade. A portion of the inboard side of the fairing which extends over the leading edge extension may be substantially planar. The substantially planar portion of the fairing may be aligned with a chord of the blade shell adjacent the fairing. Arranging the fairing as such may improve the aerodynamic performance of the fairing, e.g. so as to minimise airflow through the fairing aperture(s).

The outboard side of the fairing may be curved opposite the substantially planar portion of the fairing. Arranging the fairing as such may improve the aerodynamic performance of the fairing, e.g. so as to minimise drag due to the fairing shape.

The wind turbine blades may each comprise an inboard blade part comprising the root end and an outboard blade part comprising the tip end. The inboard blade part and the outboard blade part may be connected to each other at a split position. The inboard blade part may be joined to the outboard blade part by a connection joint. The connection joint may comprise a connector. The leading edge extension may be integrally formed with the connector. The fairing may cover the connection joint. The fairing may be secured to the connector.

The connector may be a metallic component, preferably a cast component or a machined component. The connector may be a composite component. The connector may be a co-cured or co-bonded component. Providing such a connector may improve ease of manufacture of the connector and provide a lightweight, high strength connector.

The connector may be coupled to transfer load between a spar cap portion of the inboard blade part and a spar cap portion of the outboard blade part. The connector may be arranged to transfer load from the blade connecting members into the spar cap portion of the inboard blade part. This may improve the load transfer efficiency of the turbine blade as the spar cap portions may be designed to withstand higher loads relative to the blade shell.

The connector may extend outside the profile of the blade shell at the connection joint. This may improve the load transfer across the connection joint but may require a larger fairing.

The fairing may be sealed to the blade shell. Sealing the fairing to the blade shell may prevent the ingress of water inside the fairing, may improve aerodynamic performance of the wind turbine blade, and may reduce noise generated by the wind turbine.

The connector may be a first connector, and wherein the connection joint further comprises a second connector separate to the first connector that is located towards the trailing edge of each wind turbine blade.

The wind turbine may further comprise at least three pre-tension members, each pre-tension member connected between one of the blade connecting members and the hub, each pre-tension member arranged to provide pre-tension in the blade connecting member to which it is connected.

The pre-tension members may be connected to a common point arranged at or adjacent the hub.

The hub may comprise a hub member extending from the hub substantially along a direction defined by a rotational axis of the hub. The pre-tension members may be connected to the hub member.

The wind turbine may be an upwind wind turbine.

### BRIEF DESCRIPTION OF THE DRAWINGS

Embodiments of the invention will now be described with reference to the accompanying drawings, in which:

FIG. 1 shows a front view of a wind turbine according to a first example;

FIG. 2 shows a side view of the wind turbine;

FIG. 3 shows a wind turbine according to a second example;

FIG. 4 shows a wind turbine blade;

FIG. 5 shows an exploded view of a connection joint;

FIG. 6 shows a detailed view of a connector for connecting blade portions;

FIG. 7 shows a wind turbine blade comprising a fairing and blade connecting members;

FIG. 8 shows a further view of the wind turbine blade of FIG. 7;

FIG. 9 shows a representative view of a fairing profile and a wind turbine blade profile adjacent the fairing according to a first example;

FIG. 10 shows a representative view of a fairing profile and a wind turbine blade profile adjacent the fairing according to a second example;

FIG. 11 shows a wind turbine blade comprising a fairing, a connector and two blade portions;

FIG. 12 shows a wind turbine blade comprising a fairing and blade connecting members;

FIG. 13 shows a cross section of the wind turbine blade of FIG. 12;

FIG. 14 shows a camber distribution of a fairing profile and a wind turbine blade profile adjacent the fairing;

FIG. 15 shows a thickness distribution of a fairing profile and a wind turbine blade profile adjacent the fairing;

FIG. 16 shows a cross section showing the wind turbine blade profile, the connector profile and the fairing profile at the location of the connection joint between inboard and outboard blade portions;

FIG. 17 shows a first method of sealing an aperture in a fairing;

FIG. 18 shows a second method of sealing an aperture in a fairing; and

FIG. 19 shows a third method of sealing an aperture in a fairing.

### DETAILED DESCRIPTION OF EMBODIMENT(S)

In this specification, terms such as leading edge, trailing edge, pressure surface, suction surface, thickness, and chord are used. While these terms are well known and understood to a person skilled in the art, definitions are given below for the avoidance of doubt.

The term leading edge is used to refer to an edge of the blade which will be at the front of the blade as the blade rotates in the normal rotation direction of the wind turbine rotor.

The term trailing edge is used to refer to an edge of a wind turbine blade which will be at the back of the blade as the blade rotates in the normal rotation direction of the wind turbine rotor.

The chord of a blade is the straight line distance from the leading edge to the trailing edge in a given cross section perpendicular to the blade spanwise direction. The term chordwise is used to refer to a direction from the leading edge to the trailing edge, or vice versa.

A pressure surface (or windward surface) of a wind turbine blade is a surface between the leading edge and the trailing edge, which, when the blade is in use, has a higher pressure than a suction surface of the blade.

A suction surface (or leeward surface) of a wind turbine blade is a surface between the leading edge and the trailing edge, which will have a lower pressure acting upon it than that of a pressure surface, when the blade is in use.

The thickness of a wind turbine blade is measured perpendicularly to the chord of the blade and is the greatest distance between the pressure surface and the suction surface in a given cross section perpendicular to the blade spanwise direction.

The camber of a wind turbine blade represents the asymmetry of the blade about its chord. A camber distribution may be plotted representing the median of the blade thickness along the blade chord to illustrate the camber of a blade.

The term spanwise is used to refer to a direction from a root end of a wind turbine blade to a tip end of the blade, or vice versa. When a wind turbine blade is mounted on a wind turbine hub, the spanwise and radial directions will be substantially the same.

The term spar cap is used to refer to a longitudinal, generally spanwise extending, reinforcing member of the blade. The spar cap may be embedded in the blade shell or may be attached to the blade shell. The spar caps of the windward and leeward sides of the blade may be joined by one or more shear webs extending through the interior hollow space of the blade. The blade may have more than one spar cap on each of the windward and leeward sides of the blade. The spar cap may form part of a longitudinal reinforcing spar or support member of the blade. In particular, the spar caps may form part of the load bearing structure extending in the longitudinal direction that carries the flap-wise bending loads of the blade. The spar cap may comprise spar cap portions either side of a connection joint between portions of the blade in the case of a segmented or split wind turbine blade.

The term outboard refers to a radial (blade spanwise) direction from hub of the blade towards the tip end of the blade. The term inboard refers to a radial direction from the tip end of the blade towards the hub.

The term fairing refers to an additional part or structure fitted around parts of a moving body, such as a wind turbine blade, and shaped so as to smooth the outline and reduce aerodynamic drag. Fairings generally do not form part of the primary load-being structure of the moving body.

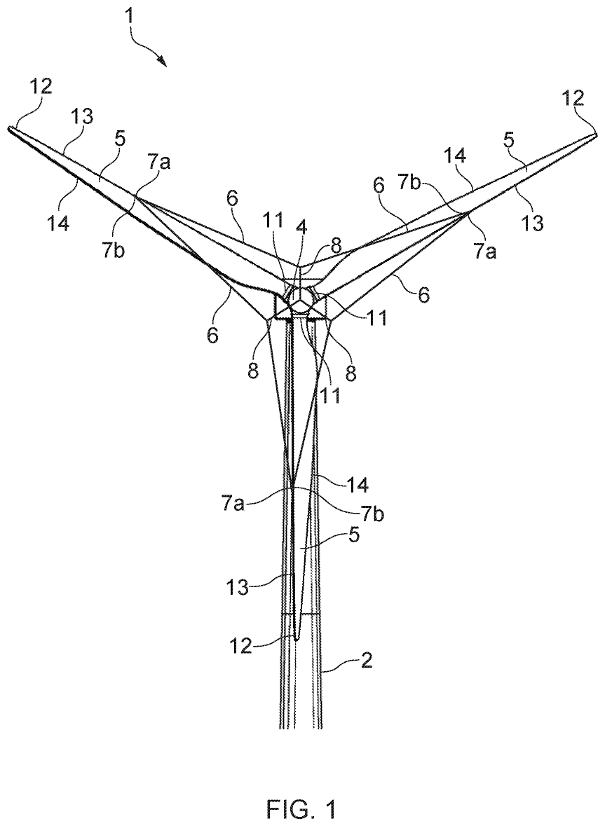

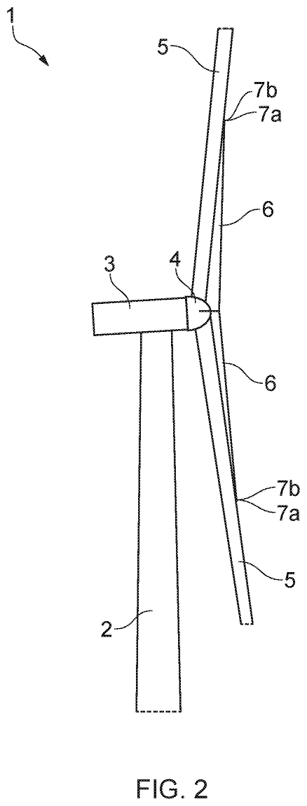

FIGS. 1 and 2 show a pitch controlled wind turbine 1 according to a first example. FIG. 1 is a front view of the wind turbine 1, and FIG. 2 is a side view of the wind turbine 1. The wind turbine 1 comprises a tower 2 and a nacelle 3 mounted on the tower 2. A hub 4 is mounted rotatably on the nacelle 3, and carries three wind turbine blades 5 projecting outwardly from the nacelle 3. While the example shown in FIGS. 1 and 2 has three blades 5, it will be appreciated that other numbers of blades 5 are possible.

When wind blows against the wind turbine 1, the wind turbine blades 5 generate a lift force which causes a generator (not shown) within the nacelle 3 to generate electrical energy.

It will be appreciated that the wind turbine 1 depicted may be any suitable type of wind turbine 1. The wind turbine 1 shown is an upwind wind turbine, although it will be appreciated the wind turbine 1 may be a downwind wind turbine. The wind turbine 1 may be an onshore wind turbine such that the foundation is embedded in the ground, or the wind turbine 1 may be an offshore installation in which case the foundation would be provided by a suitable marine platform.

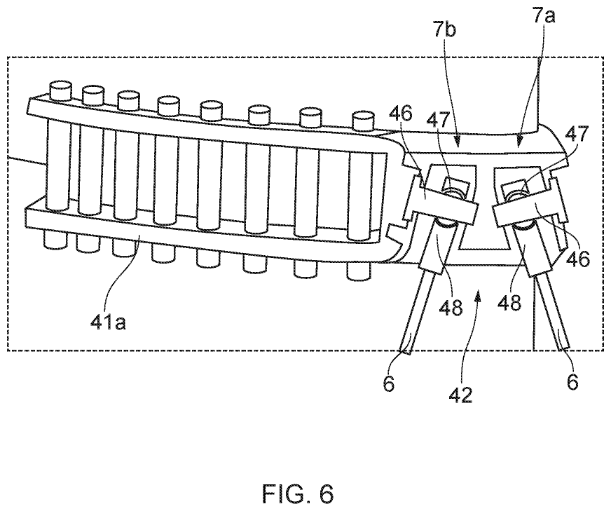

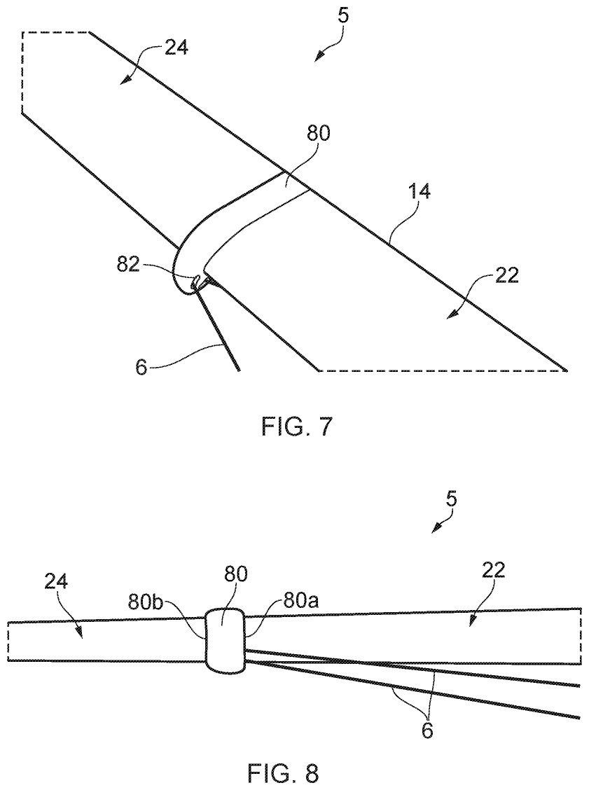

Three blade connecting members 6 interconnect neighbouring wind turbine blades 5 between connection points 7a, 7b on the wind turbine blades 5 (such as shown in further detail in FIGS. 6 and 7). The connecting members 6 are cables, e.g. steel or polymer cables.

A pre-tension member 8 may extend between one of each of the blade connecting members 6 and a common point arranged at or adjacent the hub 4. In the example shown in FIGS. 1 and 2, the pre-tension members 8 extend to the hub 4. The pre-tension members 8 are configured to provide pre-tension in the blade connecting members 6. The pre-tension members 8 are cables, e.g. steel or polymer cables.

In the absence of pre-tension members 8, the blade connecting members 6 may extend substantially straight to interconnect neighbouring wind turbine blades 5 between connection points 7a, 7b on the wind turbine blades 5 and may be pre-tensioned by a tensioning device (not shown) at each blade 5.

The pre-tensioned blade connecting members 6 cause the wind turbine blades 5 to mutually support each other, in the sense that loads on the wind turbine blades 5, in particular edgewise loads and flapwise loads, are ‘shared’ among the wind turbine blades 5. The wind turbine is preferably an upwind wind turbine.

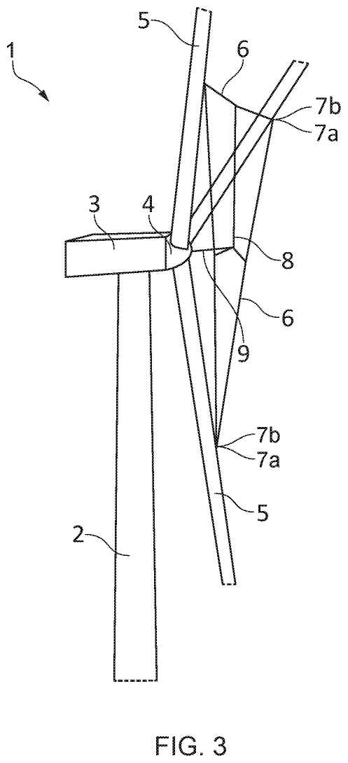

FIG. 3 is a side view of a pitch controlled wind turbine 1 according to a second example. The wind turbine 1 of FIG. 3 is similar to the wind turbine 1 of FIGS. 1 and 2, and therefore likewise features will not be described in detail here.

In FIG. 3, the pre-tension members 8 are not connected directly to the hub 4. Instead, the pre-tension members 8 are connected adjacent the hub 4, to a hub member 9 which extends from the hub 4 substantially along a direction defined by a rotational axis of the hub 4. As a result, the connection point of the pre-tension members 8 is further from the hub 4 than the example of FIGS. 1 and 2, and thereby further from the positions where the wind turbine blades 5 are connected to the hub 4. This has the consequence that the pre-tension members 8 may also pull the blade connecting members 6 away from the hub 4 and away from the tower 2. This may also cause the wind turbine blades 5 to be pulled in this direction, thereby further reducing edgewise and flapwise loads at the root of the wind turbine blades 5 and securing tower clearance, similar to what is obtained when a coning angle is introduced. Due to the use of connecting members 6, this has been found to tend to lead to increased stiffness in the inner part of the blades 5.

The wind turbine blades 5 have a root end 11 proximal to the hub 4, adapted to be connected to the hub 4 via a pitch mechanism, and a tip end 12 distal from the hub 4. The blades 5 include a leading edge 13 and a trailing edge 14 that extend between the respective root end 11 and tip end 12. The blades 5 include a blade shell that defines a suction side 15 and a pressure side 16 around the blade. A thickness dimension of the blade 5 extends between the suction side 15 and the pressure side 16.

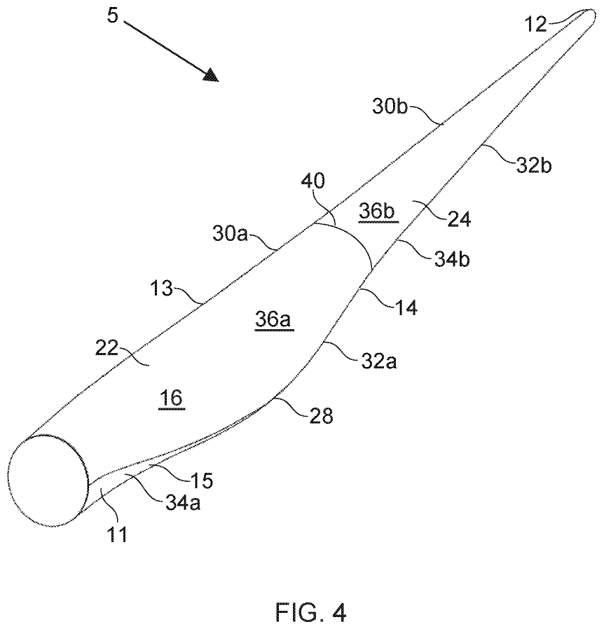

As shown in FIG. 4, each blade 5 may have a cross section which has a substantially circular profile near the root end 11. The blade 5 may transition from a circular profile to an aerofoil profile moving from the root end 11 of the blade 5 outboard. The blade 5 may comprise a “shoulder” 28 outboard of the root end 11, which is the widest part of the blade where the blade 5 has its maximum chord. The blade 5 may have an aerofoil profile of progressively decreasing thickness in an outboard portion of the blade. The progressively decreasing thickness may extend from the shoulder 28 to the tip end 12. The connecting points 7a, 7b are located forward of the leading edge 13 and adjacent the pressure side 16 on a leading edge extension of the respective blade 5. The connecting points may be between 10% and 60% of the length of the wind turbine blade 5 from the root end 11 to the tip end 12 in the radial direction but are preferably radially inboard of 50% of the length of the wind turbine blade 5 from the root end 11 to the tip end 12, and more preferably radially inboard of 45% of the length of the wind turbine blade 5 from the root end 11 to the tip end 12, e.g. around 35-40%.

Each of the blades 5 may be a split blade formed of a first blade portion 22 and a second blade portion 24 coupled together, such as shown in FIG. 4. Each blade portion 22, 24 has a shell that defines a respective leading edge 30a, 30b, trailing edge 32a, 32b, suction side 34a, 34b, and pressure side 36a, 36b.

The first portion 22 and second portion 24 of each blade 5 may be connected at a connection joint indicated by connection line 40. The connection line 40 between the first and second blade portions 22, 24 may be a spanwise split, with the connection line 40 being chordwise. The first blade portion 22 extends from the blade root 11 to the connection line 40. The second blade portion 24 extends from the blade connection line 40 to the blade tip 12.

It will be appreciated that the blade 5 may have any number of blade portions 22, 24, with respective connection joints between them.

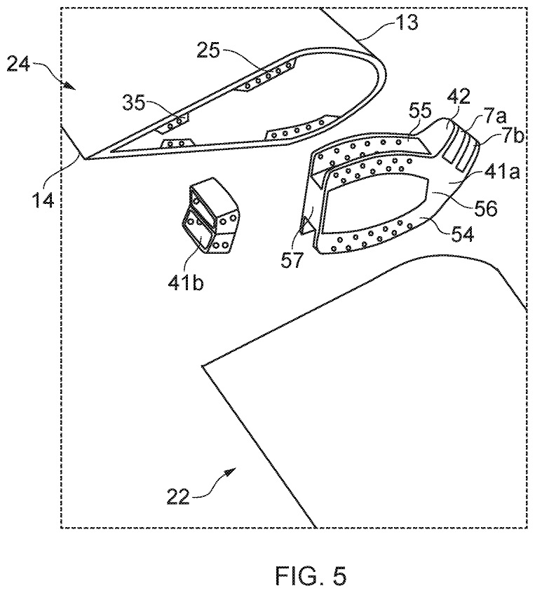

As previously referred to above, the first and second blade portions 22, 24 are coupled by a connection joint that includes a connector 41. The connector may comprise a first connector 41a and a second connector 41b, such as shown in FIGS. 5 and 6. The following description is made in relation to a connector 41 comprising a first connector 41a and a second connector 41b, however it will be appreciated that the description may similarly be applied to a connector comprising a first connector 41a only.

The connector 41 connects a first blade end surface of the first blade portion 22 to a second blade end surface of the second blade portion 24. As explained in further detail below, the connection points 7a, 7b of the connecting members 6 are on the first connector 41a at the connection joint.

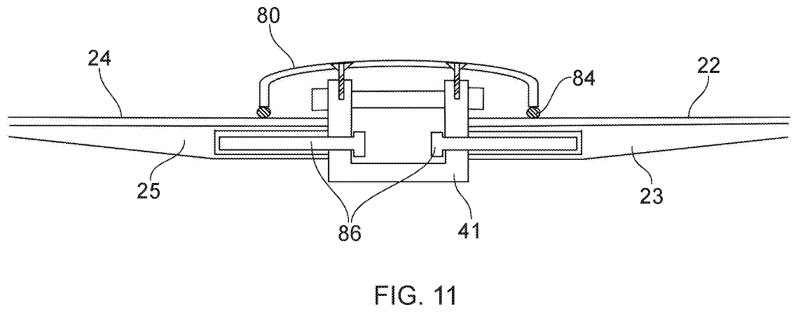

The connector 41 is adapted to transfer load between the first blade portion 22 and the second blade portion 24, and in particular between a first spar cap portion 23 (see FIG. 11) of the first blade portion 22 and a second spar cap portion 25 of the second blade portion 24.

The first connector 41a and the second connector 41b may be cast metallic components, although it will be appreciated that each may be formed of any suitable materials, e.g. composite materials, and produced by any suitable manufacturing technique, e.g. machined, co-cured or co-bonded. The first connector 41a and second connector 41b may be made from aluminium. Each of the first connector 41a and the second connector 41b are a single unitary connector component, although it will be appreciated that each connector 41a, 41b may be formed of two or more components in some examples.

In the example shown in FIG. 5, the first connector 41a includes a first branch 54 for connecting the suction side 15 of the first and second blade portions 22, 24 and a second branch 55 for connecting the pressure side 16 of the first and second blade portions 22, 24. The first and second branches 54, 55 may be connected by a first link 56 located towards the leading edge 13 of the blade 5 and connected by a second link 57 located towards the trailing edge 14 of the blade 5. In this way, a ring shape is formed by the first branch 54, second branch 55, first link 56 and second link 57. The first and second branches 54, 55 may be integrally formed with the first and second links 56, 57, although it will be appreciated that the first and second branches 54, 55 may be separate components from each other, and/or the first and second links 56, 57. It will be appreciated that the first connector 41a may take other forms, for example the second link 57 may be located away from the trailing edge 14 of the blade 5 so as to form a generally ‘A’ shaped connector.

Should the first connector 41a be used without a second connector 41b, the first connector 41a may extend across substantially the entire chord of the wind turbine blade 5, although preferably the connector 41a extends across only a portion of the chord of the wind turbine blade, such as shown in FIG. 5. This assists in reducing the weight of the first connector 41a, whilst allowing the first connector 41a to be positioned adjacent the spar cap portions of the blade portions 22, 24 that may carry the majority of the loads. The first connector 41a may include a plurality of apertures. In this manner, the first and second blade portions 22, 24 may be attached together with sets of fasteners 86 (see FIG. 11) that extend through the holes.

The first connector 41a may extend across any chordwise portion of the blade 5 adjacent the spar cap portions 25.

In some examples, the connection joint may comprise multiple, discrete, connectors 41a, 41b separated in a generally chordwise direction. This may assist in minimising the weight of the connection joint, as the connectors 41a, 41b can support discrete portions of the connection joint, where required, without requiring the connector(s) to span therebetween.

The first connector 41a is located towards the leading edge 13 of the blade 5, and may be arranged to extend up to the leading edge 13 of the blade 5. Further, the first connector 41a may comprise a leading edge extension 42 that includes connection points 7a, 7b that attach to connecting members 6.

A second connector 41b is located towards the trailing edge 14 with respect to the first connector 41a. The second connector 41b may connect to spar cap portions on the first blade section 22 (not shown) and spar cap portions 35 on the second blade section 24. The second connector 41b may include a first set of fasteners (not shown) for extending into the spar cap portion on the first blade section 33, and a second set of fasteners (not shown) for extending into the spar cap portion 35 on the second blade section 24, with the second connector 41b including a plurality of apertures through which the sets of fasteners extend so as to secure the connector 41b to the spar cap portions on the first blade section 22 and the second blade section 24.

Any reference to the connector 41 made hereinafter may refer to a connector comprising a first connector 41a only or a connector comprising both a first connector 41a and a second connector 41b.

As shown in FIG. 6, the leading edge extension 42 includes connection points 7a, 7b that attach to the connecting members 6. In the present example, the leading edge extension 42 includes first and second connection points 7a, 7b, although in alternative examples the leading edge extension 42 may comprise any suitable number of connection points. The first and second connection points 7a, 7b may be arranged forward of the leading edge 13 and adjacent the pressure side 16, such as shown in FIG. 5. This provides additional clearance for the connecting members 6 as the wind turbine blades 5 rotate with the hub 4 about the nacelle 3. In particular, sufficient clearance is provided between the connecting members 6 and the first blade portion 22 when the blades 5 are pitched between about −5 degrees and +95 degrees.

It will be appreciated that the connection points 7a, 7b may be adjacent each other on the leading edge extension 42. Alternatively, the connection points 7a, 7b may be spaced from one another. For example, a second connection point 7b may be located further towards the pressure side 16 than the first connection point 7a, e.g. the second connection point 7b may be closer to the pressure side spar cap 23,25 whereas the first connection point may remain adjacent the leading edge 13.

In some examples, the connector 41a may include multiple leading edge extensions 42 integrally formed with the connector 41a. The leading edge extensions may be spaced from each other, for example one may be located further towards the pressure side 16 than the other, with each leading edge extension 42 having a respective connection point 7a, 7b.

The connection points 7a, 7b may permit at least some freedom of movement of the connecting members 6 at its respective connection point. In the example shown in FIG. 6, the connection points 7a, 7b permit rotation of each blade connecting member 6 about the respective connection point 7a, 7b in two orthogonal rotational degrees of freedom. This allows each connecting member 6 to move independently of each other, thereby reducing constraints on the wind turbine 1.

The two orthogonal rotational degrees of freedom may be provided by a bearing structure, for example as shown in FIG. 6. In this example, the first rotational freedom is provided by a pin 46 of the bearing structure about which a respective blade connecting member 6 is rotatable, and the second rotational freedom provided by a spherical plain bearing 47 between the pin 46 and the respective connecting member 6. However, it will be appreciated that other bearing structures may be applicable.

To assist in attaching the connecting members 6 to the bearing structure, each connecting member 6 may include an eyelet 48 at one end for receiving the respective pin 46.

Each connecting member 6 is connected at the first connection point 7a to one wind turbine blade 5 and at the second connection point 7b to a neighbouring wind turbine blade, such as previously described in relation to FIG. 1 to 3.

FIGS. 7 and 8 show the wind turbine blade 5 with a fairing 80 extending over at least the leading edge extension. As mentioned previously, the wind turbine blade 5 may have a split and comprises the first blade section 22 and second blade section 24 coupled together, for example by the connector 41 as described above. With a split blade the fairing 80 may extend over the leading edge extension 42 and the connector 41.

As mentioned above, the connection points 7a, 7b are located forward of the blade leading edge 13 and adjacent the pressure side 16 on the leading edge extension 42. This is primarily to avoid clash between the blade connecting members 6 and the blade 5 as the blade pitch varies. The fairing 80 preferably has an aerofoil profile to minimise drag. The profile of fairing 80 preferably is as small as possible whilst also minimising drag. Whilst it may be expected that the aerofoil profile of the fairing 80 should be similar to a profile of the blade shell adjacent the fairing, it has surprisingly been found that the fairing profile may be optimised by providing a fairing profile that is twisted nose down with respect to a profile of the blade shell adjacent the fairing. This is thought to be due to the leading edge extension 42 being on the pressure side 16 of the blade, the need to cover the leading edge extension with an aerodynamic fairing, minimising the overall size of the fairing, and trading these criteria against suboptimal lift created by the aerofoil profile of the fairing compared to the profile of the blade shell adjacent the fairing.

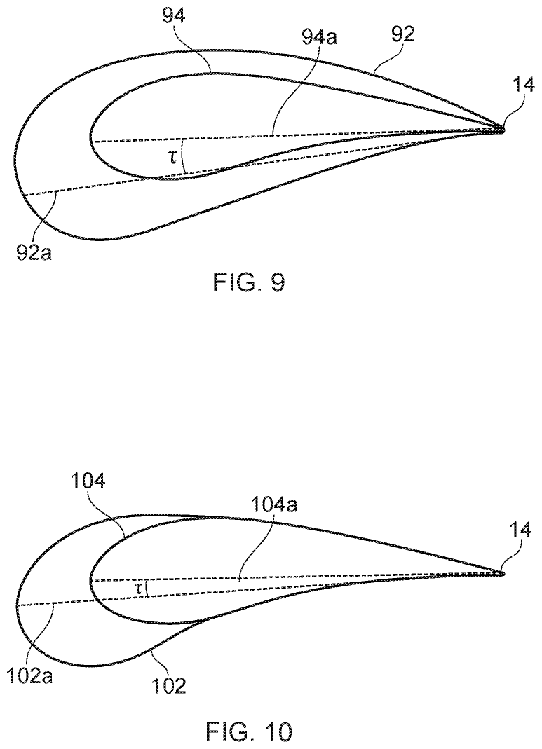

FIGS. 9 and 10 show exemplary representative views of different fairing profiles 92, 102 and blade shell profiles 94, 104. The fairing aerofoil profile may have a different shape than the blade shell aerofoil profile adjacent the fairing.

In FIG. 9, the fairing profile 92 extends over the leading edge extension and up to the trailing edge 14 of the blade 5. In FIG. 10, the fairing profile 102 extends over the leading edge extension but meets and is coincident with the blade shell profile 104 forward of the blade trailing edge 14. The broken lines in FIGS. 9 and 10 show the chord of each of the different fairing profiles 92a, 102a and blade shell profiles 94a, 104a. As can be seen the chord of the fairing profiles 92a, 102a in each case is twisted nose down (negative incidence to the oncoming airflow) with respect to the profile of the blade shell 94a, 104a. The nose down pitch may define an angle τ, and τ may be less than 30 degrees, or less than 20 degrees, or less than 10 degrees, for example around 5 degrees.

As shown in FIG. 9, the fairing profile 92 may be larger than the blade shell profile 94 at all points about the profile apart from the trailing edge such that the fairing 80 encloses the wind turbine blade 5. In particular, the fairing profile 92 may be at its largest relative to the blade shell profile 94 towards the leading edge of the aerofoil on the pressure surface. This arrangement may house the leading edge extension 42 described previously, which may extend beyond the leading edge of the blade shell profile 94.

Alternatively, as shown in FIG. 10, the fairing 80 may be designed as an overlaminate to the blade shell over a rear portion of the blade shell profile. In this case, the fairing 80 and blade shell may have an identical profile extending from a trailing edge such that the first section 22, fairing 80 and second section 24 form a substantially contiguous surface towards the trailing edge of the turbine blade 5. The fairing 80 may then deviate from the blade shell such that the fairing profile 102 extends forward of the leading edge of the blade profile 104 so as to extend over the leading edge extension 42. This may be achieved by providing a cut out in the blade shell of the first section 22 and the blade shell of the second section 24 of the wind turbine blade 5, the cut out having a depth equal to the fairing 80 wall thickness. The fairing profile 80 may deviate from the blade shell profile on the pressure side 16 and the suction side 15 at the same chord position of the blade shell profile, or at different chord positions of the blade shell profile. The fairing profile 102 may deviate from the blade shell profile 102 at a chordwise position of less than 0.6; less than 0.4; or less than 0.2 of the blade shell chord.

The fairing 80 extends over at least over the leading edge extension 42 and may extend at least up to the trailing edge 14, 32a, 32b of the blade 5.

The fairing 80 may comprise at least one aperture 82, each aperture 82 arranged such that a blade connecting member 6 may extend from the connection point 7a, 7b on the leading edge extension 42, through the aperture 8 and towards the connection point 7a, 7b on a neighbouring wind turbine blade 5. The size and shape of an aperture 82 may be different to any other apertures 82 depending on the intended direction that a blade connecting member 6 is to extend from its connection point 7a, 7b through the fairing 80. Each aperture 82 may take any shape-by way of non-limiting example each aperture may be substantially circular, substantially ovoid, elongate, kidney-shaped or any combination of shapes thereof. The shape of an aperture 82 may be selected such that the blade connecting member 6 which passes therethrough and which makes a range of angles with the leading edge extension 42 throughout the pitch range of motion of the wind turbine blade 5 (e.g. −5 degrees to +95 degrees) is accommodated by the aperture 82 without impingement, yet it may be desirable that the aperture be as small as possible. The example illustrated in FIGS. 7 and 8 shows a fairing 80 comprising two apertures 82, with one blade connecting member 6 extending through each of the two apertures 82. It will be appreciated however that multiple blade connecting members 6 may be arranged to extend through a single aperture 82.

FIGS. 7 and 8 illustrate the fairing 80 having an inboard side 80a facing towards the root of the wind turbine blade 5 and an outboard side 80b facing towards the tip of the wind turbine blade 5. The inboard side 80a may comprise a portion extending over the leading edge extension 42 that is preferably substantially planar. Said planar portion of the inboard side 80a may further be aligned with the chord of the blade shell. Any fairing apertures 82 may be arranged on the inboard side 80a of the fairing 80. Providing the apertures in this arrangement may reduce the likelihood of airflow, rain and debris from entering through apertures 82 to the interior of the fairing. Reducing airflow through the apertures 82 may result in less noise generated by the wind turbine. Further, by aligning the planar portion of the inboard side 80a with the chord of the blade shell, the inboard side 80a may serve as an aerodynamic fence, which may prevent any undesirable spanwise flow over the wind turbine blade 5. The outboard side 80b may comprise a portion extending over the leading edge extension 42 on the opposite side to the inboard side 80a planar portion. Said portion of the outboard side 80b may be curved. This curved outboard side 80b of the fairing may improve the aerodynamic performance of the fairing 80, e.g. so as to minimise drag due to the curved fairing shape. The fairing may therefore be asymmetric about its mid-plane containing the blade thickness and chordwise dimensions.

The fairing 80 may comprise multiple separate panels fastened together using any suitable method, such as fasteners. Each panel may weigh less than 10 kg, to minimise the risk of damage should the panel become detached from the wind turbine blade. Adjacent panels may overlap to increase the strength of the fairing 80 at the intersections between panels. The panels may be fastened together upon assembly of the wind turbine blade 5, and the fairing 80 may be fastened to the connector 41 using any suitable method, such as bolts. Smaller bolts may be used to fasten the panels together than those used to fasten the fairing 80 to the connector 41, since the loads between panels will be less than those between the fairing 80 and the connector 41. Any apertures 82 may be formed by gaps between fairing panels 80 or by apertures in the panels themselves. The fairing 80 may be made of fibre glass, and may comprise foam material within the fairing 80, which may reduce the acoustic signature of the fairing 80 when air flows over the fairing.

The first blade section 22 and/or the second blade section 24 may comprise engagement features corresponding with engagement features on the fairing 80. Engagement features may be load bearing and/or used to align the fairing 80 with the wind turbine blade 5 during assembly. The engagement features may comprise at least one channel into which the fairing 80 may be inserted and/or at least one extrusion onto which the fairing 80 may be fastened. The first blade section 22 and the second blade section 24 may comprise different engagement features. Any corresponding engagement features on the fairing 80 may be formed integrally with the fairing 80. Providing engagement features between the turbine blade 5 and the fairing 80 may improve the strength of the joint when fastening or otherwise attaching the fairing 80 to the wind turbine blade 5.

The fairing 80 may comprise means for removing any water or debris that has entered inside the fairing 80, e.g. through the apertures 82. These means may include a maintenance plug and/or a weep hole.

The external surface of the fairing 80 may comprise vortex generators or flow channels. Any combination of serrations, channels, and extrusions may be provided. These may be provided to improve the aerodynamic performance of the fairing 80 and/or to reduce the noise of air flowing over the fairing. Any such features may be located on any combination of the pressure side 16, suction side 15, inboard side 80a and outboard side 80b of the fairing 80.

As shown in FIG. 11, the fairing 80 may be sealed to the blade shell by any suitable means, such as a sealant 84 around blade shell. Sealing the fairing 80 to the blade shell may improve the aerodynamic performance of the turbine blade 5; may prevent water ingress into the interior of the fairing 80 from outside; and may reduce noise caused by air flowing over the wind turbine blade 5. Similar benefits may instead be achieved by not sealing the fairing 80 to the blade shell, and instead designing the gap between the fairing 80 and the blade shell to generate a vortex as air flows into the gap, thus generating an aerodynamic seal between the fairing 80 and blade shell.

Where the wind turbine blade 5 comprises a first section 22 and a second section 24 of a split blade, the fairing 80 may be designed so as to accommodate a modular wind turbine blade 5 design. By way of non-limiting example, multiple second sections 24 having different spanwise lengths may be provided that may be fastened to a common first section 22 via the connector 41. The fairing 80 may be designed so as to accommodate these different second sections 24, allowing the user to vary the diameter of the wind turbine rotor by selecting a second section 24 of the turbine blade 5 with a different span length. This may be beneficial in areas where legislation limits the allowable size of wind turbines. It is preferable that the first section 22 and any second sections 24 have similar blade profiles adjacent the fairing 80, so as not to affect the aerodynamic performance of the overall turbine blade 5.

The fairing 80 may extend over the entirety of the connection line 40 at the split between the first section 22 and second section 24 of the turbine blade 5, including the leading edge extension 42.

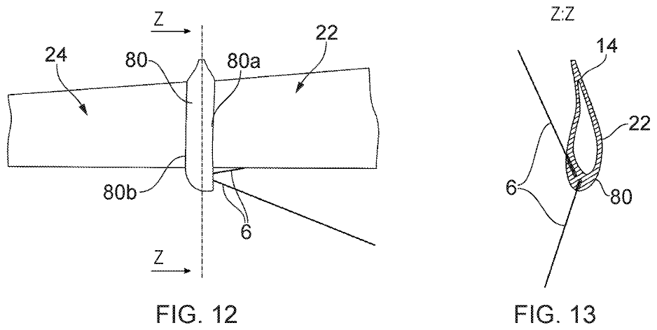

The fairing 80 may extend beyond the trailing edge 14 of the blade 5, as shown in FIGS. 12 and 13. FIG. 13 shows a cross section view taken through the mid span of the fairing 80 about the plane Z: Z in FIG. 12.

The fairing 80 may have a width measured parallel to the spanwise direction of the blade 5. Should the fairing 80 extend beyond the trailing edge 14, the portion of the fairing 80 extending beyond the trailing edge 14 may have a proximal end and a distal end, the distal end arranged further from the blade trailing edge than the proximal end. It is expected that the apertures 82 in the fairing 80 and the exit of the blade connecting members 6 through the apertures 82 will create some vortices. Extending the fairing 80 beyond the blade trailing edge 14 may guide the vortices and release them downstream of the trailing edge of the blade, so that the vortices do not disrupt the flow on the blade itself. Where the fairing 80 is formed of multiple fairing panels connected together, extending the fairing 80 beyond the blade trailing edge 14 may assist with joining the windward and leeward sides of the fairing together away from the blade trailing edge 14.

The portion of the fairing 80 extending beyond the trailing edge 14 may have a width-wise taper. The width of the fairing 80 at the distal end may be less than the width of the fairing 80 at the proximal end as is illustrated in FIG. 10. Preferably the width of the fairing 80 at the distal end may be less than 20% of the width of the fairing 80 at the proximal end. The taper may be a linear taper of reducing width towards the distal end, or the rate of taper may increase or decrease towards the distal end. By providing a taper of reducing width of the fairing 80 beyond the blade trailing edge 14 may reduce pressure drag on the trailing edge of the fairing itself.

As shown in FIG. 13 the fairing aerofoil profile may fully encompass the blade shell aerofoil profile. However, it will be appreciated that even when the trailing edge of the fairing 80 extends beyond the trailing edge of the blade shell, a portion of the fairing profile may still be contiguous with the blade shell profile.

The fairing 80 and blade shell adjacent the fairing may each have a camber distribution. The fairing camber distribution 132 (at the fairing mid-span) may be different than the blade shell camber distribution 134 (adjacent the fairing 80). The fairing camber distribution 132 may be greater than the blade shell camber distribution 134 at all equivalent non-dimensionalised chordwise positions. The fairing camber distribution 132 may comprise a single maximum value, or multiple inflection points. The blade shell camber distribution 134 may comprise a single maximum value, or multiple inflection points.

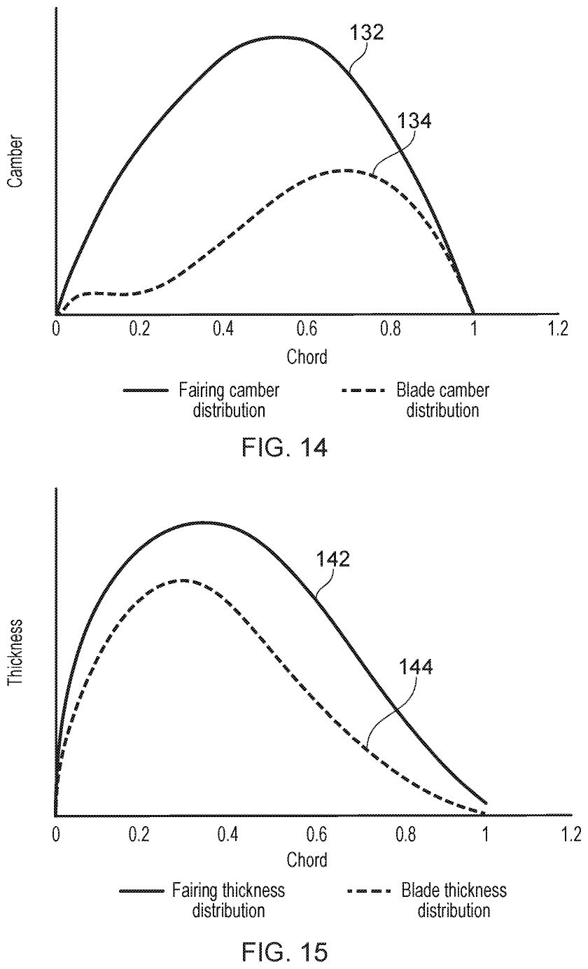

FIG. 14 shows an example of a fairing profile camber distribution 132 compared to a blade shell profile camber distribution 134 adjacent the fairing 80, both camber distributions being non-dimensionalised for comparison. The fairing camber distribution 132 is different than blade shell profile camber distribution 134. The fairing camber distribution 132 has a larger camber than the blade shell camber at all chordwise points of the profiles, and the maximum fairing camber may be greater than 150% of the maximum of the blade shell camber. The fairing camber distribution 132 may have a generally parabolic shape defining a singular maximum value. By contrast, the blade shell camber distribution 143 may define two or more maxima and/or at least three inflection points as illustrated by FIG. 14.

The fairing 80 and blade shell adjacent the fairing may each have a thickness distribution. The fairing thickness distribution 142 (at the fairing mid-span) may be different than the blade shell thickness distribution 144 (adjacent the fairing 80). The fairing thickness may be greater than the blade shell thickness at all equivalent non-dimensionalised chordwise positions. The fairing thickness distribution 142 may be skewed rearwardly compared to the blade shell thickness distribution 142, so that the non-dimensionalised maximum fairing thickness occurs at a further aft chordwise position than does the maximum blade thickness. Both the fairing thickness distribution 142 and the blade shell thickness distribution 144 may define a single maximum value.

FIG. 15 shows an example of a fairing profile thickness distribution 142 compared to a blade shell profile thickness distribution 144 adjacent the fairing 80, both thickness distributions being non-dimnsionalised. The fairing profile thickness distribution 142 is different than the blade shell profile thickness distribution 144. The fairing profile thickness 142 is greater than the blade shell profile thickness 144 at all points across the wind turbine blade 5. The maximum value of the fairing thickness may be greater than 125% of the maximum value of the blade shell thickness.

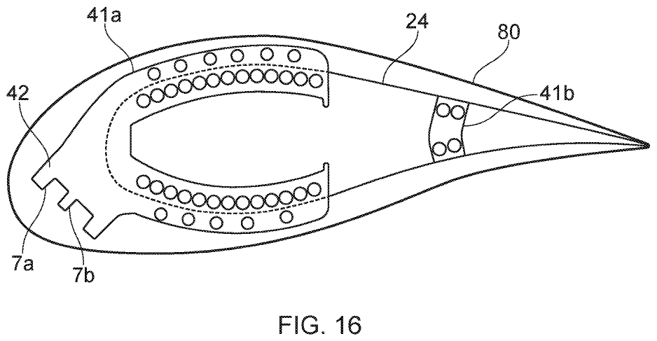

FIG. 16 shows a cross section view of an assembled wind turbine blade 5, taken through the mid-span plane of the connector 41. Shown is the profile of the fairing 80 and the blade shell second blade portion 24, the fairing 80 extending to enclose the leading edge extension 42 comprising the connection points 7a, 7b. In the illustrated example, the connector 41 comprises a first connector 41a and a second connector 41b, each connector fastened to spar cap portions (not shown) on the second blade portion 24 using fasteners (not shown). The connector 41 may extend beyond the pressure side 16 and/or the suction side 15 of the blade shell. The connector provides a surface onto which the fairing 80 may be fastened.

The fairing 80 may further comprise a seal or cover for sealing or covering the aperture 82, e.g. to prevent airflow or the ingress of water through the aperture 82 and into the inside of the fairing 80. Any such seals may be designed to be completely watertight, to prevent the majority of water ingress, to prevent only limited water ingress, or to prevent any level of water ingress therebetween. Sealing of the apertures 82 may be achieved by providing a means of flexibly sealing or partially covering the aperture 82 in the fairing 80 around the blade connecting member 6. Connections that are flexible and/or oversized may be provided so as not to restrict movement of the blade connecting members 6 as the blade pitches.

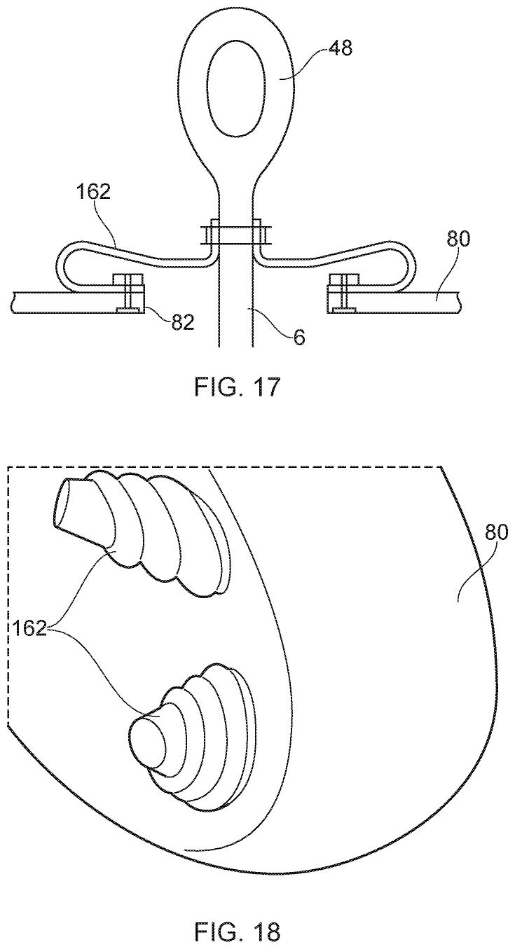

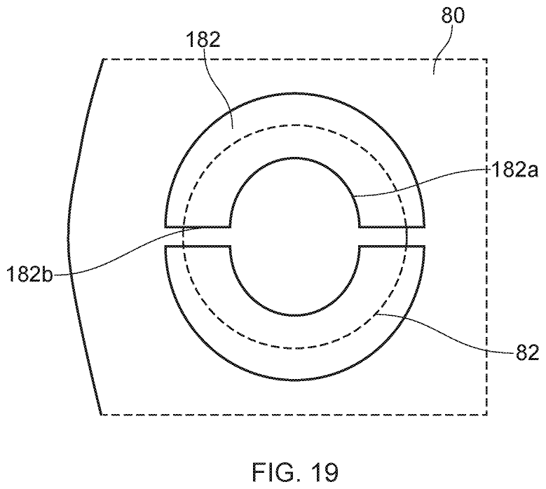

FIGS. 17, 18 and 19 show three potential methods of sealing or covering the aperture 82. FIG. 17 shows a membrane 162 fastened to the inner surface of the fairing 80 and the blade connecting member 6, the membrane 162 extending entirely around the aperture 82 to form a waterproof seal. FIG. 18 shows two seals 172 fastened to the external surface of fairing 80 and the blade connecting member 6, each seal 172 arranged to cover aperture 82. FIG. 19 shows a disk seal 182 comprising a central aperture 182a through which connecting member 6 may pass, and a slit 182b such that the connecting member can move within the disk seal 182. Any suitable connection may be used to fasten or couple the membrane 162, seals 172 or disk seal 182 to the fairing 80, such as adhesives, biased clips, or a clamping ring. Any suitable connection may be used to fasten or couple the membrane 162 or seal 172 to blade connecting member 6, such as a hose clamp. The membrane 162, seals 172 and the disk seal 182 may be flexible to allow movement of the blade connecting member 6. The membrane 162, seals 172 and disk seal 182 may be made from a polymer and may be designed so as not to degrade in the presence of saltwater. Any combination of sealing methods described by FIGS. 16, 17 and 18 may be used on the same wind turbine 1, optionally on the same fairing 80.

Although the invention has been described above with reference to one or more preferred embodiments, it will be appreciated that various changes or modifications may be made without departing from the scope of the invention as defined in the appended claims

1. A pitch controlled wind turbine comprising a tower, a nacelle mounted on the tower, a hub mounted rotatably on the nacelle, and at least three wind turbine blades, wherein each wind turbine blade extends between a root end connected to the hub via a pitch mechanism, and a tip end, the wind turbine further comprising:
at least three blade connecting members, each blade connecting member extending from a connection point on one wind turbine blade towards a connection point on a neighbouring wind turbine blade, where the connection point on a given wind turbine blade is arranged at a distance from the root end and at a distance from the tip end of the wind turbine blade;
wherein each wind turbine blade comprises a leading edge, a leading edge extension, and a blade shell defining a suction side and a pressure side around the blade,
wherein the leading edge extension extends forward of the leading edge, and the connection point of the respective wind turbine blade is located forward of the leading edge and adjacent the pressure side on the leading edge extension, and each wind turbine blade further comprises a respective fairing extending over at least the leading edge extension,
wherein the fairing has a profile which is twisted nose down with respect to a profile of the blade shell adjacent the fairing.

2. The pitch controlled wind turbine of claim 1, wherein each wind turbine blade has a trailing edge and the respective fairing extends at least up to the trailing edge.

3. The pitch controlled wind turbine of claim 2, wherein the fairing extends beyond the trailing edge, wherein the fairing has a width, and a portion of the fairing extending beyond the trailing edge has a width-wise taper.

4. The pitch controlled wind turbine of claim 1, claim, wherein the fairing profile is an aerofoil profile, and the fairing aerofoil profile has a different shape than an aerofoil profile of the blade shell adjacent the fairing.

5. The pitch controlled wind turbine of claim 1, claim, wherein the fairing profile has a camber distribution, and the camber distribution of the fairing is different than a camber distribution of the profile of the blade shell adjacent the fairing.

6. The pitch controlled wind turbine of claim 1, claim, wherein the fairing profile has a thickness distribution, and the thickness distribution of the fairing is different than a thickness distribution of the profile of the blade shell adjacent the fairing.

7. The pitch controlled wind turbine of claim 1, claim, wherein each wind turbine blade is coupled to two of the blade connecting members, each of the two blade connecting members extending from respective connection points of one of the blades, and wherein the connection points of the one of the wind turbine blades are adjacent each other on the same leading edge extension.

8. The pitch controlled wind turbine of claim 1, claim, wherein the respective fairing has at least one aperture, wherein at least one of the blade connecting members extends from the connection point on the leading edge extension covered by the fairing and through the aperture towards the connection point on the neighbouring wind turbine blade.

9. The pitch controlled wind turbine of claim 8, wherein each aperture is substantially ovoid and/or elongate and/or kidney-shaped.

10. The pitch controlled wind turbine of claim 8, dependent on claim 7, wherein each wind turbine blade is coupled to two of the blade connecting members, each of the two blade connecting members extending from respective connection points of one of the blades, wherein the connection points of the one of the wind turbine blades are adjacent each other on the same leading edge extension, wherein the respective fairing has two of the apertures, and wherein a respective one of the two blade connecting members extends through a respective one of the two apertures.

11. The pitch controlled wind turbine of claim 8, wherein the one or more apertures are covered or sealed around the one or more blade connecting members.

12. The pitch controlled wind turbine of claim 1, preceding claim, wherein the respective fairing has an inboard side facing towards the root end of the wind turbine blade, and an outboard side facing towards the tip end of the wind turbine blade, wherein a portion of the inboard side of the fairing which extends over the leading edge extension is substantially planar, wherein the substantially planar portion of the fairing is aligned with a chord of the blade shell adjacent the fairing.

13. The pitch controlled wind turbine of claim 12, wherein the outboard side of the fairing is curved opposite the substantially planar portion of the fairing.

14. The pitch controlled wind turbine of claim 1, wherein the wind turbine blades each comprise an inboard blade part comprising the root end and an outboard blade part comprising the tip end, the inboard blade part and the outboard blade part being connected to each other at a split position, and wherein the inboard blade part is joined to the outboard blade part by a connection joint, the connection joint comprising a connector, wherein the leading edge extension is integrally formed with the connector, and wherein the fairing covers the connection joint, wherein the fairing is secured to the connector.

15. The pitch controlled wind turbine of claim 14, wherein the connector is a metallic component.

16. The pitch controlled wind turbine of claim 14, wherein the connector is coupled to transfer load between a spar cap portion of the inboard blade part and a spar cap portion of the outboard blade part, and is arranged to transfer load from the blade connecting members into the spar cap portion of the inboard blade part.

17. The pitch controlled wind turbine of claim 14, wherein the connector extends outside the profile of the blade shell at the connection joint.

18. The pitch controlled wind turbine of claim 1, claim, wherein the fairing is sealed to the blade shell.
